(19) United States
(12) Patent Application Publication
(10) Pub. No.: US 2006/0279782 A1
(43) Pub. Date: Dec. 14, 2006

(54) Apparatus and method for selecting files from a plurality of recording media and printing files

(75) Inventor: Yong-im Kim, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/450,463

(22) Filed: Jun. 12, 2006

(30) Foreign Application Priority Data
Jun. 11, 2005 (KR) 2005-50137

(51) Int. Cl. G06K 15/00

(52) U.S. Cl. 358/1.16; 358/1.9; 358/1.1

(57) ABSTRACT

An apparatus and method for selecting and printing files from a plurality of recording media. The apparatus includes: an input unit to connect to the recording media and input thumbnail information from image files stored on the recording media; a storage unit to store the thumbnail information; a displayer to display the thumbnail information stored in the storage unit; and a controller to control the storage unit to store each of the thumbnail information and the displayer to display the thumbnail information on a screen. The method includes connecting a plurality of recording media to a printing unit or a multi-functional device having a printing function, storing thumbnail information from the recording media in the storage unit, and displaying the stored thumbnail information at one time, thereby displaying images stored on the plurality of recording media all at one time, and selecting a desired image file from the displayed thumbnail images.

### CROSS-REFERENCE TO RELATED APPLICATIONS

This application claims the benefit of Korean Patent Application No. 2005-50137, filed Jun. 11, 2005, in the Korean Intellectual Property Office, the disclosure of which is incorporated herein in its entirety by reference.

### BACKGROUND OF THE INVENTION

1. Field of the Invention

Aspects of the present invention relate to an apparatus and method for selecting a file from a plurality of recording media and printing the file, and more particularly, to an apparatus and method for inputting thumbnail information stored in a plurality of recording media, storing the input thumbnail information in a storage unit, displaying the stored thumbnail information all at one time, and selecting and printing a file desired by a user at one time.

2. Description of the Related Art

Conventionally, a user connects each of a plurality of recording media to a printer and confirms images of each stored on the recording media via an LCD window to select and print files stored on the recording media. This conventional process is repeatedly performed by the number of times of the recording media, which makes it difficult to select images stored in a plurality of recording media.

When the user wishes to output specific images from a multitude of images which are taken at a place and stored on two separate recording media, the user must confirm the images twice to select and print them. When the user reconfirms an image stored in a recording medium, the user must search for the recording medium in which the image is stored, stop a current operation, and connect the found recording medium to the printer. The process causes a waste of time and inconvenience to the user when searching for and outputting an image or a file in a plurality of recording media.

### SUMMARY OF THE INVENTION

Aspects of the present invention provide an apparatus and method for connecting a plurality of recording media to a printer or a multi-functional device having a printing function, inputting thumbnail information stored on the plurality of recording media, storing the input thumbnail information in a storage unit, and displaying the stored thumbnail information all at one time, thereby allowing a user to select and print a desired file at one time in order to solve problems of only displaying images stored in one recording medium at one time although the images are taken at a place, and displaying and selecting images stored in another recording medium by separating a previous recording medium from the printer and reconnecting the other recording medium to the printer.

According to an aspect of the present invention, there is provided an apparatus to select and print files from a plurality of recording media, the apparatus comprising: an input unit to connect to the recording media and to input thumbnail information of images stored on the recording media; a storage unit to store the input thumbnail information; a displayer to display the thumbnail information stored in the storage unit; and a controller to control the storage unit to store each of the thumbnail information and the displayer to display the thumbnail information on a screen when the plurality of recording media are connected to the input unit.

While not required in all aspects, the controller may create a print order list of the selected files when files to be printed are selected using the displayer.

While not required in all aspects, the apparatus may further include: a printing unit to print the selected files, wherein the controller controls the printing unit to print the selected files according to the print order list.

While not required in all aspects, the controller may create the print order list to print selected files stored in a currently connected recording medium before printing other files stored on other recording media.

While not required in all aspects, the controller may group files stored on a recording medium and print the grouped files.

While not required in all aspects, the controller may control the printing unit to print files stored in the currently connected recording medium according to the print order list before being connected to other recording media and printing files stored in other recording media.

While not required in all aspects, the apparatus may further include: a print option unit selecting a print option for printing files stored in the plurality of recording media.

While not required in all aspects, when the recording media are connected to the input unit, the input unit may store an identification number and thumbnail information of the connected recording media in the storage unit.

While not required in all aspects, the identification number may be identity driver information (IDI) and card information structure (CIS) of the recording media.

According to another aspect of the present invention, there is provided a method of selecting a file from a plurality of recording media and printing the file, the method comprising: connecting the plurality of recording media and inputting thumbnail information of images stored on the recording media; storing the input thumbnail information in a storage unit; and displaying the thumbnail information stored in the storage unit on a screen.

While not required in all aspects, the method may further include: selecting files to be printed from the displayed files; and creating a print order list of the selected files.

While not required in all aspects, the method may further comprise: printing the selected files according to the print order list.

While not required in all aspects, creating the print order list of the selected files can include, designating those selected files stored on a currently connected recording medium to be printed before printing other files stored in other recording media.

While not required in all aspects, creating a print order list of the selected files can include grouping files stored in a common recording medium and the grouped files are printed.

While not required in all aspects, printing the selected files according to the print order list can include, files stored in the currently connected recording medium may be printed according to the print order list before connecting to another recording medium and printing other files stored in the other recording medium.

While not required in all aspects, the method may further include selecting a print option for printing files stored in the plurality of recording media before connecting the plurality of recording media and inputting thumbnail information of images stored on the recording media.

While not required in all aspects, when the recording media are connected, an identification number and thumbnail information of the connected recording media may be stored in the storage unit.

While not required in all aspects, the identification number may be an IDI and a CIS of the recording media.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus for selecting a file from a plurality of recording media and printing the file according to an embodiment of the present invention;

FIG. 2 is a flowchart of a method of selecting a file from a plurality of recording media and printing the file according to an embodiment of the present invention; and

FIG. 3 exemplarily illustrates thumbnail images stored on recording media A and B and thumbnail images displayed on a displayer in Operation 230 shown in FIG. 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

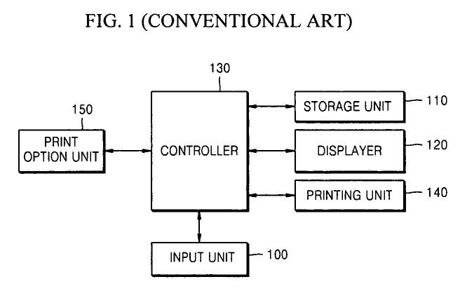

FIG. 1 is a block diagram of an apparatus for selecting a file from a plurality of recording media and printing the file according to an embodiment of the present invention. Referring to FIG. 1, the apparatus comprises an input unit 100, a storage unit 110, a displayer 120, a controller 130, a printing unit 140, and a print option unit 150.

The input unit 100 is connected to a recording medium (not shown) and inputs thumbnail information from the connected recording medium. The recording medium may be a flash memory, a portable memory card, a memory of a device such as a cell phone or a digital camera, an optical disc, a DVD, a magnetic tape, a floppy disk, etc. The input unit 100 checks an identification number of the recording medium. As a result of checking the identification number, if the input unit 100 is again connected to a previously connected recording medium with no new thumbnail information, the input unit 100 requests for connection to a new recording medium. However, if the input unit 100 is connected to the new recording medium, the input unit 100 obtains the thumbnail information of the new recording medium and stores the obtained thumbnail information in the storage unit 110. Similarly, when the input unit 100 is connected to a previously connected recording medium with new thumbnail information, the input unit 100 obtains the new thumbnail information and stores the new thumbnail information in the storage unit 110. The recording media can be connected to the input unit 100 in series, i.e., one after another, or in parallel, i.e., a plurality of recording media connected to the input unit 100 simultaneously. The identification number is identity driver information (IDI) and card information structure (CIS) of a recording medium.

The storage unit 110 stores the input thumbnail information. The storage unit 110 processes externally input data using the controller 130 and uses the data as spooler or page information.

The displayer 120 displays the thumbnail information stored in the storage unit 110. The displayer 120 includes a liquid crystal display (LCD) window for displaying the thumbnail information and selects a file stored in a movable recording medium through the LCD window or monitors status of a printer. Although the current embodiment describes the displayer 120 as part of the apparatus, it is understood that the present invention is not limited thereto, that is, the displayer 120 can be an external display such as a flat panel monitor and/or a touch screen device. The displayer may include a separate input key for a user to select a file. The input key may be a click wheel, mouse button, remote controller, voice activated, keyboard key, etc.

The controller 130 selects files to be printed through the displayer 120 and creates a print order list of the selected files. The controller 130 controls the printing unit 140 to print the selected files according to the print order list. Although not required in all aspects it is understood that the printing unit 140 may be a printing apparatus such as a copier, laser printer, inkjet printer, or a multi-functional device having a printing function.

The controller 130 creates the print order list to print a file stored in a currently connected recording medium in the selected files before printing other files stored in other recording media. Also, the controller 130 creates the print order list to group files stored in a common recording medium and print the files at one time.

After printing files stored in the currently connected recording medium according to the print order list, the controller 130 controls the printing unit 140 to be connected to other recording media and print other files stored in other recording media.

The printing unit 140 prints the selected files. The printing unit 140 stops printing when it recognizes during a printing operation that a selected image to be printed is not stored on the currently connected recording medium, and outputs a message indicating that connection to the recording medium storing the selected image is requested.

The print option unit 150 selects an option for printing files stored in the plurality of recording media. When the print option unit 150 does not select the option, a general printing process is performed. When the print option unit 150 selects the option, one or more files are selected from the plurality of recording media and the selected files are printed using a printing function described as follows.

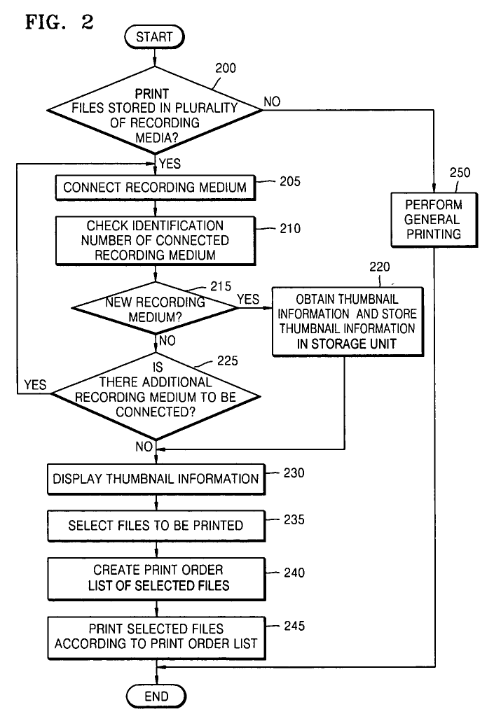

FIG. 2 is a flowchart of a method of selecting and printing one or more files from a plurality of recording media according to an embodiment of the present invention. The method will now be described with reference to FIG. 1.

Referring to FIGS. 1 and 2, a user selects an option for printing one or more files from files stored in the plurality of recording media using the print option unit 150 (Operation 200). When the option for printing a file form files stored in the plurality of recording media is not selected in the print option unit 150, a general printing process of connecting a recording medium to the input unit 100, displaying a prompt to identify the file to be printed, such as “what?”, on the displayer 120, selecting a file to be printed, and printing the selected file is performed (Operation 250).

When the option for printing files stored in the plurality of recording media is selected in the print option unit 150 (Operation 200), a recording medium is connected to the input unit 100 (Operation 205). An identification number of the connected recording medium is checked (Operation 210). As a result of checking the identification number, when a new recording medium is connected to the input unit 100, thumbnail information is obtained from the new recording medium connected to the input unit 100 and stored in the storage unit 110 (Operation 220).

As a result of checking the identification number, when a previously connected recording medium is connected to the input unit 100 with no new thumbnail information (Operation 215), connection to a new recording medium is requested (Operation 225). When there is a new recording medium or a previously connected recording medium with new thumbnail information to be connected to the input unit 100, the new recording medium or previously connected recording medium with new thumbnail information is connected to the input unit 100 in Operation 205. If there is no recording medium to be connected to the input unit 100, the thumbnail information obtained from the plurality of recording media and stored in the storage unit 110 is displayed on the displayer 120 (Operation 230).

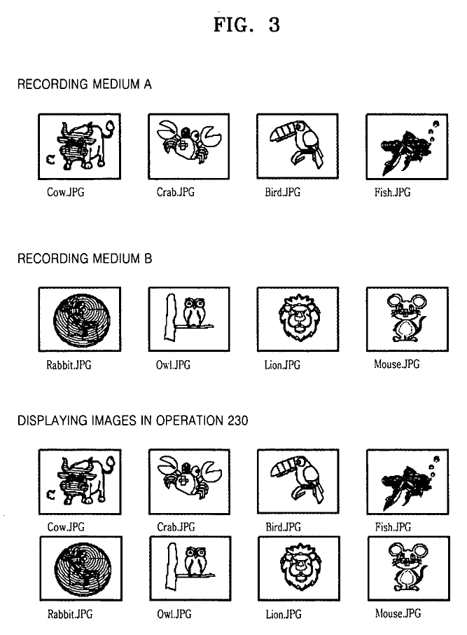

FIG. 3 exemplarily illustrates thumbnail images stored on recording media A and B and thumbnail images displayed on the displayer 120 in Operation 230 shown in FIG. 2. Referring to FIG. 3, recording medium A stores image files Cow. JPG, Crab.JPG, Bird.JPG, and Fish.JPG, and recording medium B stores image files Rabbit.JPG, Owl.JPG, Lion.JPG, and Mouse.JPG. When the thumbnail images of the images stored on the recording media A and B are stored in the storage unit 110 in Operations 200 through 225, and the thumbnail images stored in the storage unit 110 are displayed on the displayer 120 in Operation 230, a screen displays all the thumbnail images of the image files Cow. JPG, Crab.JPG, Bird.JPG, Fish.JPG, Rabbit.JPG, Owl.JPG, Lion.JPG, and Mouse.JPG. Although the example files have JPG extensions corresponding to JPEG (Joint Photographic Experts Group) file format, it is understood that the present invention is not limited thereto, that is, the files on the recording media can be any format such as TIF (Tagged Image File Format), GIF (Graphics Interchange Format), DOC (MICROSOFT WORD), etc.

The user selects files to be printed from the thumbnail images displayed on the displayer 120 (Operation 235). After selecting files to be printed, the controller 130 creates a print order list to print the selected files (Operation 240). The controller 130 creates the print order list to print a file of the selected files stored in a currently connected recording medium before printing other files stored in other recording media. Also, the controller 130 preferably creates the print order list to group files together that are stored on a common recording medium and print such files at one time for efficiency.

After the print order list is created, the selected files are printed by the printing unit 140 according to the created print order list (Operation 245). Files stored in a currently connected recording medium are printed first, a next recording medium is connected to the printing unit 140 according to the print order list, and files stored in the next recording medium are printed. The connecting recording media and printing is repeated until files selected from all the recording media are printed.

Aspects of the present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves.

According to aspects of the present invention, a plurality of recording media are connected to a printer or a multi-functional device having a printing function, thumbnail information stored on the recording media is stored in the storage unit, and the stored thumbnail information is displayed at one time, thereby displaying images stored in the plurality of recording media at one time to allow efficient selection and printing of a desired image from the displayed images.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus to select and print files from a plurality of recording media, the apparatus comprising:
an input unit to connect to the recording media and input a thumbnail information of an image stored on the recording media;
a storage unit to store the input thumbnail information;
a displayer to display the thumbnail information stored in the storage unit; and
a controller, when the plurality of recording media are connected to the input unit, to control the storage unit to store the thumbnail information and to control the displayer to display the thumbnail information on a screen.

2. The apparatus of claim 1, wherein more than one of the plurality of recording media are connected to the input unit simultaneously.

3. The apparatus of claim 1, wherein the controller, when files to be printed are selected using the displayer, creates a print order list of the selected files.

4. The apparatus of claim 3, further comprising:
a printing unit to print the selected files, wherein the controller controls the printing unit to print the selected files according to the print order list.

5. The apparatus of claim 3, wherein the controller creates the print order list to print files of the selected files stored on a currently connected recording medium before printing other files stored in other recording media.

6. The apparatus of claim 4, wherein the controller controls the printing unit to print files stored on the currently connected recording medium according to the print order list before being connected to another recording medium and printing files stored on the other recording medium.

7. The apparatus of claim 4, further comprising: a print option unit to select a print option for printing files stored on the plurality of recording media.

8. The apparatus of claim 1, wherein, when the recording media are connected to the input unit, the input unit stores an identification number and thumbnail information of the connected recording media in the storage unit.

9. A method of selecting a file from a plurality of recording media and printing the file, the method comprising:
connecting the plurality of recording media and inputting thumbnail information of images stored on the recording media;
storing the input thumbnail information in a storage unit; and
displaying the thumbnail information stored in the storage unit on a screen.

10. The method of claim 9, wherein the connected plurality of recording media are connected at one time.

11. The method of claim 9, wherein the connecting the plurality of recording media further comprises:
removing recording media after inputting thumbnail information of images stored on the recording media; and
connecting additional recording media and inputting thumbnail information of images stored on the additional recording media.

12. The method of claim 9, further comprising:
selecting files to be printed from the displayed thumbnail information; and
creating a print order list of the selected files.

13. The method of claim 12, further comprising printing the selected files according to the print order list.

14. The method of claim 13, wherein the printing the selected files according to the print order list includes ceasing printing when a selected file to be printed is not stored on the currently connected recording medium and displaying a message indicating that connection to one of the recording media storing the selected image is requested.

15. The method of claim 12, wherein the creating of the print order list includes, files of the selected files stored on a currently connected recording medium are designated by the print order list to print before printing other files stored on other recording media.

16. The method of claim 15, wherein the creating of the print order list includes, grouping files stored on a common recording medium together and printing the grouped files.

17. The method of claim 13, wherein the printing of the selected files according to the print order list, includes printing files stored in the currently connected recording medium according to the print order list before connecting to another recording medium and printing other files stored in the another recording medium.

18. The method of claim 13, further comprising, before connecting the plurality of recording media and inputting thumbnail information of an image stored on the recording media, selecting a print option for printing files stored on the plurality of recording media.

19. The method of claim 9, wherein, in connecting the plurality of recording media and inputting thumbnail information of images stored on the recording media, when the recording media are connected, an identification number and thumbnail information of the connected recording media are stored in the storage unit.

20. The method of claim 19 wherein the identification number is identity driver information (IDI) and a card information structure (CIS) of the recording media.

21. The method of claim 19, wherein the connecting of the plurality of recording media includes checking the identification number and when the currently connected recording medium is identified as having been previously connected and containing no new thumbnail information, requesting a connection to a new recording medium.

22. An apparatus to select and print files from a multitude of files on a plurality of recording media, comprising:
an input unit to connect to the recording media and input thumbnail information of the recording media files;
a storage unit to store the thumbnail information;
a displayer to display the thumbnail information;
an input key to select a list of thumbnail information; and
a printer to print the files on the recording media corresponding to the list of selected thumbnail information.

23. A method of selecting and printing files from a multitude of files on a plurality of recording media, comprising:
connecting a plurality of recording media;
inputting thumbnail information of recording media files;
storing the thumbnail information of the recording media files;
displaying the thumbnail information;
selecting a list of the thumbnail information; and
printing the files corresponding to the selected thumbnail information.
